(19) United States
(12) Patent Application Publication
(10) Pub. No.: US 2023/0224729 A1
(43) Pub. Date: Jul. 13, 2023

(54) WIRELESS COMMUNICATION DEVICE AND WIRELESS COMMUNICATION METHOD

(71) Applicant: NIPPON TELEGRAPH AND TELEPHONE CORPORATION, Tokyo (JP)

(72) Inventors: Mitsuki NAKAMURA, Musashino-shi, Tokyo (JP); Wataru YAMADA, Musashino-shi, Tokyo (JP); Yasuhiko INOUE, Musashino-shi, Tokyo (JP); Shoko SHINOHARA, Musashino-shi, Tokyo (JP); Yusuke ASA, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 17/999,841

(22) PCT Filed: May 28, 2020
(86) PCT No.: PCT/JP2020/021172

§ 371 Date: Nov. 23, 2022

(51) Int. Cl. H04W 24/02; H04W 24/10

(52) U.S. Cl. CPC H04W 24/02; H04W 24/10

(57) ABSTRACT

A radio communication apparatus according to an embodiment includes a radio communication unit (1011), a radio information acquisition unit (1013), and a transmission condition setting unit (104). The radio communication unit transmits a radio signal. The radio information acquisition unit continuously acquires radio information containing received signal strength in the radio communication unit. The transmission condition setting unit sets a transmission time slot for transmitting the radio signal in the radio communication unit and an index value of a modulation and error correction coding rate in the radio communication unit in accordance with the radio information.

### TECHNICAL FIELD

Embodiments relate to a radio communication apparatus and a radio communication method.

### BACKGROUND ART

An environment where a surrounding condition dynamically changes, such as a heavy traffic place, causes a value representing communication quality, such as received signal strength (RSSI), to greatly fluctuate depending on time or the like. In addition, since resources cannot be managed in an unlicensed band, which requires no license, the band can be influenced by interference during communication. This may cause greatly different communication quality depending on a time slot in which communication is performed or the like in the unlicensed band. Internet of Things (IoT) terminals or the like need periodical and stable communication, and thus, guarantee of the communication quality is awaited.

### CITATION LIST

### Patent Literature

PTL 1: JP 2017-143460 A

### SUMMARY OF THE INVENTION

### Technical Problem

The embodiments that have been made in view of the above circumstances provide a radio communication apparatus and a radio communication method capable of performing stable communication in a dynamic environment.

### Means for Solving the Problem

A radio communication apparatus according to an embodiment includes a radio communication unit, a radio information acquisition unit, and a transmission condition setting unit. The radio communication unit transmits a radio signal. The radio information acquisition unit continuously acquires radio information containing received signal strength in the radio communication unit. The transmission condition setting unit sets a transmission time slot for transmitting the radio signal in the radio communication unit and an index value of a modulation and error correction coding rate in the radio communication unit in accordance with the radio information.

### Effects of the Invention

The embodiment allows for providing a radio communication apparatus and a radio communication method capable of performing stable communication in a dynamic environment.

### BRIEF DESCRIPTION OF DRAWINGS

FIG. 1 is a diagram illustrating an example of a configuration of a radio system according to an embodiment.

FIG. 2 is a diagram illustrating an example of a configuration of a base station.

FIG. 3 is a diagram illustrating an example of a configuration of a terminal.

FIG. 4 is a diagram illustrating an example of a functional configuration of the base station.

FIG. 5 is a flowchart illustrating an example of an operation of the base station.

### DESCRIPTION OF EMBODIMENTS

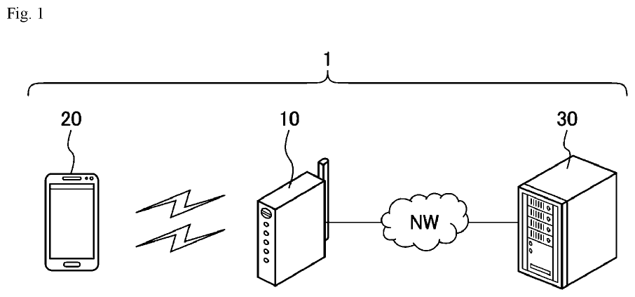

Embodiments will be described below with reference to the drawings. FIG. 1 illustrates an example of a configuration of a radio system 1 according to an embodiment. As illustrated in FIG. 1, the radio system 1 includes a base station 10, a terminal 20, and a server 30, for example.

The base station 10 is a radio communication apparatus that is connected to a network NW and is used as an access point for radio LAN. The base station 10 can transmit, by radio, data received from the network NW to the terminal 20. The base station 10 may be connected to the terminal 20 by using a plurality of different channels. Communication between the base station 10 and the terminal 20 is based on the IEEE 802.11 standard, for example.

The terminal 20 is a radio communication apparatus such as a smartphone and a tablet PC. The terminal 20 can transmit and receive data to and from the server 30 on the network NW via the base station 10 connected by radio. The terminal 20 may be another electronic device such as a desktop computer or a laptop computer. The terminal 20 may be communicable with at least the base station 10.

The server 30 can hold various information, and holds, for example, content data for the terminal 20. For example, the server 30 is connected to the network NW by wire and is configured to be communicable with the base station 10 via the network NW. The server 30 may be communicable with at least the base station 10. That is, the communication between the base station 10 and the server 30 may be wired communication or radio communication.

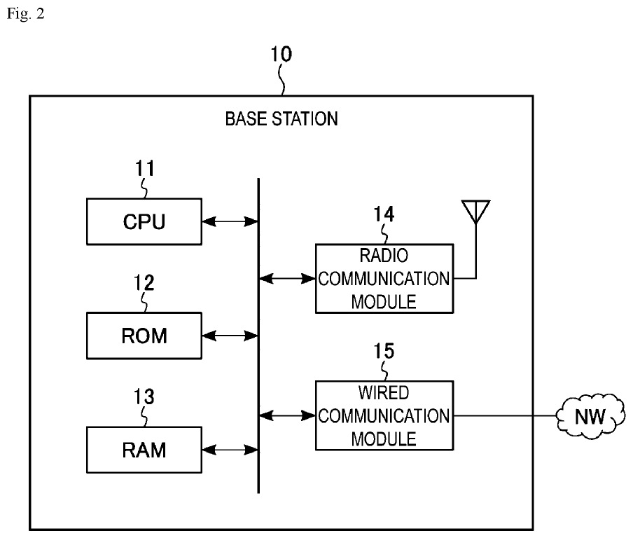

FIG. 2 illustrates an example of a configuration of the base station 10. As illustrated in FIG. 2, for example, the base station 10 includes a central processing unit (CPU) 11, a read only memory (ROM) 12, a random access memory (RAM) 13, a radio communication module 14, and a wired communication module 15.

The CPU 11 is a circuit capable of executing various programs and controls an overall operation of the base station 10. An ASIC or the like may be used instead of the CPU. In addition, the number of CPUs 11 may not be one but two or more. The ROM 12 is a non-volatile semiconductor memory and holds a program, control data, and the like for controlling the base station 10. The RAM 13 is, for example, a volatile semiconductor memory and is used as a work area of the CPU 11. The radio communication module 14 is a circuit used for transmitting and receiving data by a radio signal and is connected to an antenna. The radio communication module 14 includes, for example, a plurality of communication modules respectively corresponding to a plurality of frequency bands. The wired communication module 15 is a circuit used for transmitting and receiving data by a wired signal, and is connected to the network NW.

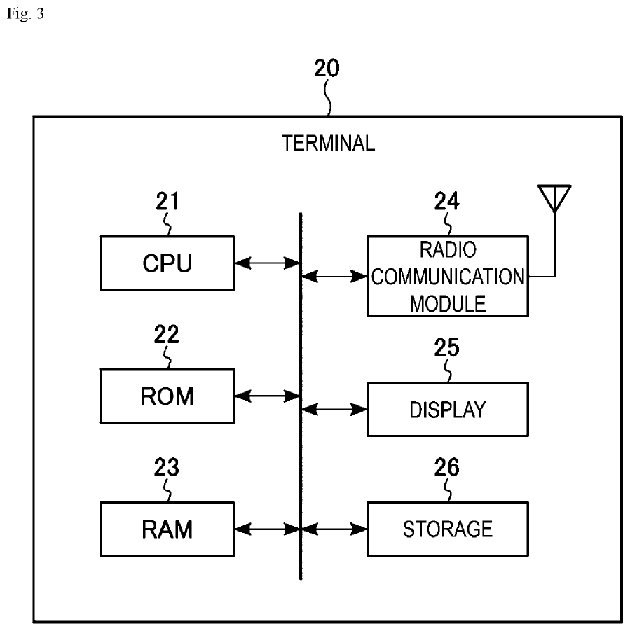

FIG. 3 illustrates an example of a configuration of the terminal 20. As illustrated in FIG. 3, for example, the terminal 20 includes a CPU 21, a ROM 22, a RAM 23, a radio communication module 24, a display 25, and a storage 26.

The CPU 21 is a circuit capable of executing various programs and controls an overall operation of the terminal 20. An ASIC or the like may be used instead of the CPU. In addition, the number of CPUs 21 may not be one but two or more. The ROM 22 is a non-volatile semiconductor memory, and holds a program, control data, and the like for controlling the terminal 20. The RAM 23 is, for example, a volatile semiconductor memory and is used as a work area of the CPU 21. The radio communication module 24 is a circuit used for transmitting and receiving data by a radio signal and is connected to an antenna. The radio communication module 24 includes, for example, a plurality of communication modules respectively corresponding to a plurality of frequency bands. The display 25 displays a graphical user interface (GUI) or the like corresponding to application software. The display 25 may have a function as an input interface of the terminal 20. The storage 26 is a nonvolatile storage device and holds system software and the like of the terminal 20.

The radio system 1 performs data communication based on an open systems interconnection (OSI) reference model, for example. In the OSI reference model, a communication function is divided into seven layers (first layer: physical layer, second layer: data link layer, third layer: network layer, fourth layer: transport layer, fifth layer: session layer, sixth layer: presentation layer, seventh layer: application layer). The data link layer includes, for example, a logical link control (LLC) layer and a media access control (MAC) layer. In the present specification, the third layer to the seventh layer are referred to as “higher layers” based on the data link layer.

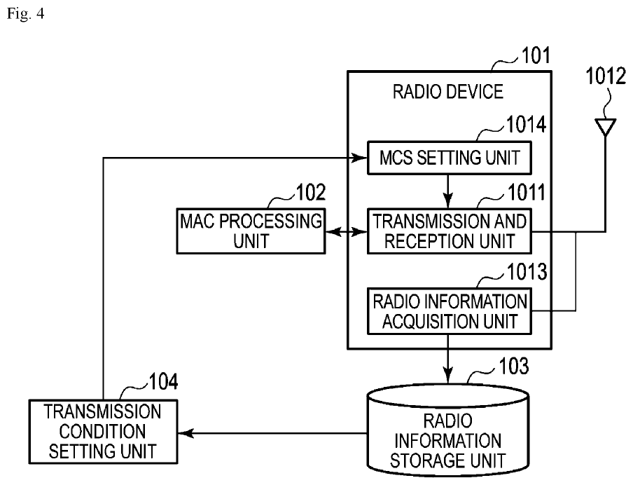

FIG. 4 illustrates an example of a functional configuration of the base station 10. As illustrated in FIG. 4, the base station 10 includes, for example, a radio device 101, a MAC processing unit 102, a radio information storage unit 103, and a transmission condition setting unit 104. The radio device 101, the MAC processing unit 102, and the transmission condition setting unit 104 are achieved by, for example, the CPU 11 and the radio communication module 14. The radio information storage unit 103 is achieved by, for example, the ROM 12 or the RAM 13.

The radio device 101 performs processing related to transmission and reception of a radio signal. The radio device 101 may include a plurality of radio devices that handle radio signals of different channels. The radio device 101 includes a transmission and reception unit 1011, an antenna 1012, and a radio information acquisition unit 1013, and an MCS setting unit 1014.

When transmitting a radio signal, the transmission and reception unit 1011 as a radio communication unit performs processing of a first layer (physical layer) on a MAC frame input from the MAC processing unit 102 to generate a radio signal and transmits the radio signal to the terminal 20 via the antenna 1012. When receiving a radio signal, the transmission and reception unit 1011 performs the processing of the first layer on the radio signal received from the terminal 20 via the antenna 1012 to restore the MAC frame, and outputs the MAC frame to the MAC processing unit 102.

The antenna 1012 is an antenna including antenna elements for transmitting and receiving radio signals. The antenna 1012 may include a single antenna element or a plurality of antenna elements.

The radio information acquisition unit 1013 continuously acquires radio information. The radio information contains received signal strength (RSSI) in the transmission and reception unit 1011. RSSI represents the communication quality in the transmission and reception unit 1011 and refers to the reception strength of a radio signal received by the transmission and reception unit 1011. The RSSI is measured from, for example, reception strength of a response signal from the terminal 20 to a beacon signal periodically broadcast from the base station 10. In addition, the RSSI may be measured from, for example, reception strength of a response signal from the terminal 20 to a request signal periodically transmitted from the base station 10 to the specific terminal 20.

The MCS setting unit 1014 sets a modulation and coding scheme (MCS) in the transmission and reception unit 1011 in accordance with the condition set by the transmission condition setting unit 104. The MCS is an index value associated with the modulation scheme and the error correction coding rate. The modulation scheme includes, for example, a modulation scheme such as BPSK (binary phase shift keying), QPSK (quadrature phase shift keying), 8PSK, 16QAM (quadrature amplitude modulation), 64QAM, and 256QAM. One or a plurality of error correction coding rates are combined and indexed for each modulation scheme. The MCS setting unit 1014 selects the index value satisfying the condition set by the transmission condition setting unit 104 among the index values available in the transmission and reception unit 1011.

The MAC processing unit 102 may perform processing of the second layer (data link layer). When transmitting a radio signal, the MAC processing unit 102 performs the processing of the second layer on data transferred from the server 30 or the like to generate a MAC frame, and outputs the MAC frame to the radio device 101. In addition, when receiving a radio signal, the MAC processing unit 102 performs the processing of the second layer on the MAC frame transferred from the radio device 101 to restore data.

The radio information storage unit 103 stores radio information. The radio information storage unit 103 may be capable of storing radio information over a certain time period such as one minute, one day, one week, or one month. Thus, the time variation of the radio information may be acquired.

The transmission condition setting unit 104 sets the transmission condition in the transmission and reception unit 1011 based on the radio information stored in the radio information storage unit 103. The transmission condition includes a condition of the transmission time slot and a condition of the MCS. Details of the processing of the transmission condition setting unit 104 will be described later.

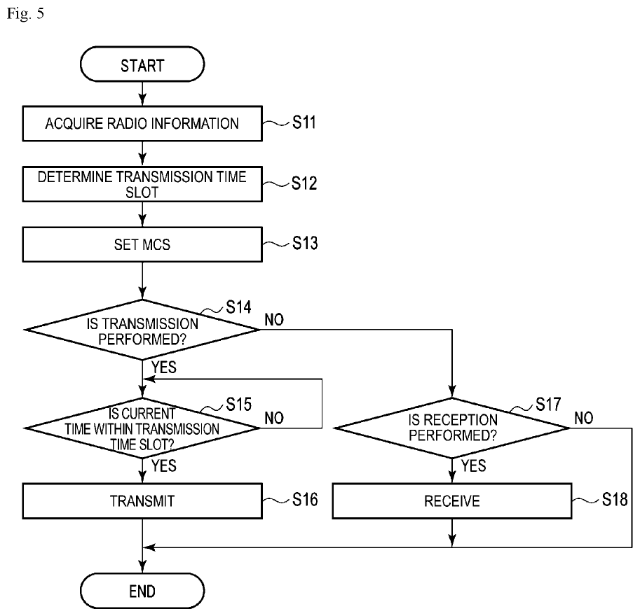

Next, an operation of the radio communication system 1 will be described. First, the operation of the base station 10 will be described. FIG. 5 is a flowchart illustrating an example of the operation of the base station 10. In Step S11, the base station 10 acquires radio information. As described above, the RSSI as radio information is measured from, for example, the reception strength of a response signal from the terminal 20, to a beacon signal. The response signal includes a terminal identifier for identifying the terminal 20. The terminal 20 is distinguished by the terminal identifier, and thus the number of terminals 20 using the channel of the radio device 101 may be specified. In addition, the RSSI may be measured from, for example, reception strength of a response signal from the terminal 20 to a request signal periodically transmitted from the base station 10 to the specific terminal 20.

In Step S12, the base station 10 determines the transmission time slot. Here, the determination in Step S12 will be described. The base station 10 determines, for example, a time slot in which a propagation environment is stable in one day, as the transmission time slot, based on a time variation of the stored radio information. The time slot in which the propagation environment is stable is, for example, a time slot in which the RSSI exceeds a threshold value over a time period that is longer than a certain threshold value. The threshold value for such a time period may be set as appropriate. For example, the terminal compliant with IEEE 802.11ah standard has a limitation of the transmission time called the duty ratio 10% rule. The duty ratio 10% rule is a rule for defining that each transmission needs to be performed within 10% of the entire communicable time. Here, the RSSI in the environment with no interference from other base stations is high. In this case, the probability that retransmission is required also decreases, and as a result, the transmission time tends to decrease. Thus, a time slot in which the propagation environment is stable may be determined by the threshold value of the RSSI satisfying the duty ratio 10% rule. The RSSI to be compared to the threshold value may be a minimum value, an average value, or a median value within a predetermined period. In addition, the RSSI to be compared to the threshold value may be a variation from the threshold value.

In addition, the transmission time slot may be determined based on the value of the RSSI acquired immediately before transmission of the radio signal. For example, if an acquisition interval of the RSSI is sufficiently small, the variation between the RSSI acquired immediately before transmission of the radio signal and the RSSI at the time of transmission of the radio signal is considered small. In this case, if the RSSI acquired immediately before transmission of the radio signal exceeds the threshold value, the propagation environment is considered stable at the time of transmitting the radio signal. Thus, the period of transmission of the radio signal can be considered to be the transmission time slot.

Furthermore, the transmission time slot may be determined based on the variation of the RSSI instead of the absolute value of the RSSI. For example, if the variation of the RSSI is within a predetermined range over a time period that is longer than a certain threshold value, the propagation environment is considered stable. Thus, such a time period can be considered to be the transmission time slot.

Here, in Step S12, when the number of times of acquiring the RSSI does not satisfy the number required to determine the transmission time slot, the process of Step S12 may be omitted.

In Step S13, the base station 10 sets the MCS in the transmission time slot. Here, the determination in Step S13 will be described. For example, when the RSSI in the transmission time slot is predicted to be higher than the threshold value, the base station 10 sets the MCS capable of large-capacity transmission as the MCS in the transmission time slot. The MCS capable of large-capacity transmission is an MCS corresponding to a modulation scheme (for example, 256 QAM) capable of transmitting the more volume of information in one transmission of a radio signal among the modulation schemes available in the transmission and reception unit 1011. In addition, the MCS capable of large-capacity transmission is an MCS that is less than the number of times of inserting error correction codes.

When the RSSI in the transmission time slot is predicted to be lower than the threshold value, the base station 10 sets the MCS having a less probability of an occurrence of a communication error, as the MCS in the transmission time slot. For example, when the variation of the RSSI is within the predetermined range, the absolute value of the RSSI may be lower than the threshold value. In such a case, the RSSI in the transmission time slot is predicted to be lower than the threshold value. The MCS having a small probability of the occurrence of the communication error is an MCS corresponding to a modulation scheme (for example, BPSK) capable of transmitting the less volume of information in one transmission of a radio signal among the modulation schemes available in the transmission and reception unit 1011. In addition, the MCS having a small probability of the occurrence of the communication error is the MCS that is more than the number of times of inserting the error correction codes.

In Step S14, the base station 10 determines whether to transmit a radio signal. For example, when data is input from the server 30, it is determined to transmit a radio signal. When it is determined in Step S14 that the radio signal is transmitted, the process transitions to Step S15. When it is determined in Step S14 that the radio signal is not transmitted, the process transitions to Step S17.

In Step S15, the base station 10 determines whether the current time is within the transmission time slot. In Step S15, when it is determined that the current time is not within the transmission time slot, the base station 10 waits for the process. In Step S15, when it is determined that the current time is within the transmission time slot, the process transitions to Step S16.

In Step S16, the base station 10 transmits a radio signal in accordance with the MCS previously set. Then, the processing of FIG. 5 is ended.

In Step S17, the base station 10 determines whether to receive a radio signal. For example, when the radio signal has been received from the antenna 1012, it is determined to receive the radio signal. When it is determined in Step S17 that the radio signal is received, the process transitions to Step S18. When it is determined in Step S17 that the radio signal is not transmitted, the processing of FIG. 5 is ended.

In Step S18, the base station 10 receives a radio signal. Then, the processing of FIG. 5 is ended.

As described above, according to the embodiment, the transmission time slot is determined based on the continuously acquired RSSI, and a radio signal is transmitted in the transmission time slot. Thus, when the propagation environment changes dynamically, a radio signal is transmitted under a stable propagation environment with less interference or the like.

In addition, in the embodiment, the MCS in the transmission time slot is set based on the RSSI. This makes it possible to perform large-capacity transmission under a condition of a favorable propagation environment, and to perform transmission having high communication success rate under a condition of a poor propagation environment. As a result, the communication quality is guaranteed. In addition, since the number of retransmissions decreases, power consumption may also be suppressed.

### First Modification Example

Hereinafter, modification examples of the embodiment will be described. In the above-described embodiment, the base station 10 acquires the radio information to determine the transmission time slot and set the MCS. When the terminal 20 includes the radio information acquisition unit and the transmission condition setting unit, the terminal 20 may acquire the radio information to determine the transmission time slot and set the MCS.

### Other Modified Examples

The processing in the aforementioned embodiment can also be stored as a program that a CPU being a computer, and the like can be caused to execute. In addition, the processing can be stored and distributed in a storage medium of an external storage device such as a magnetic disk, an optical disc, or a semiconductor memory. Then, the CPU and the like can execute the aforementioned processing by reading the program stored in the storage medium of the external storage device and by the read program controlling operations.

The present disclosure is not limited to the above-mentioned embodiment but can be variously modified in the implementation stage without departing from the gist of the present disclosure. In addition, an appropriate combination of embodiments can also be implemented, in which a combination of their effects can be obtained. Further, the above-mentioned embodiment includes various disclosures, which can be designed by combining constituent elements selected from a plurality of constituent elements disclosed here. For example, a configuration in which some constituent elements are removed from all the constituent elements illustrated in the embodiment can be designed as a disclosure if the problems can be solved and the effects can be achieved.

### REFERENCE SIGNS LIST

1 . . . Radio system
10 . . . Base station
11 . . . CPU
12 . . . ROM
13 . . . RAM
14 . . . Radio communication module
15 . . . Wired communication module
20 . . . Terminal
21 . . . CPU
22 . . . ROM
23 . . . RAM
24 . . . Radio communication module
25 . . . Display
26 . . . Storage
30 . . . Server
101 . . . Radio device
102 . . . MAC processing unit
103 . . . Radio information storage unit
104 . . . Transmission condition setting unit
1011 . . . Transmission and reception unit
1012 . . . Antenna
1013 . . . Radio information acquisition unit
1014 . . . MCS setting unit

1. A radio communication apparatus comprising:
a processor; and
a storage medium having computer program instructions stored thereon, when executed by the processor, perform to:
transmit a radio signal;
continuously acquire radio information containing received signal strength; and
set a transmission time slot for transmitting the radio signal and an index value of a modulation and error correction coding rate in accordance with the radio information.

2. The radio communication apparatus according to claim 1, wherein the computer program instructions further perform to
sets, as the transmission time slot, a time slot in which time having the received signal strength exceeding a threshold value is longer than predetermined time.

3. The radio communication apparatus according to claim 1, wherein the computer program instructions further perform to
sets, when the received signal strength acquired during a period of acquiring the radio information immediately before transmission of the radio signal exceeds a threshold value, a period of the transmission of the radio signal as the transmission time slot.

4. The radio communication apparatus according to claim 1, wherein the computer program instructions further perform to
sets, as the transmission time slot, a time slot in which a variation of the received signal strength is within a predetermined range.

5. The radio communication apparatus according to claim 1, wherein the computer program instructions further perform to sets the index value of the modulation and error correction coding rate in accordance with the received signal strength.

6. The radio communication apparatus according to claim 5, wherein the computer program instructions further perform to
sets, when the received signal strength exceeds a threshold value, the index value of the modulation and error correction coding rate as the index value of the modulation and error correction coding rate that supports large-capacity transmission.

7. A radio communication method comprising:
transmitting, by a radio communication unit, a radio signal;
continuously acquiring radio information containing received signal strength in the radio communication unit; and
setting a transmission time slot for transmitting the radio signal in the radio communication unit and an index value of a modulation and error correction coding rate in the radio communication unit in accordance with the radio information.
